(19) United States
(12) Patent Application Publication
(10) Pub. No.: US 2008/0252435 A1
(43) Pub. Date: Oct. 16, 2008

(54) Tire Identification System, Tire Pressure Monitoring System Using The Same and Method For Tire Identification

(76) Inventors: Chao-Heng CHIEN, TAIPEI (TW); Ying-Chun YU, Taipei (TW)

Correspondence Address: HOLLAND & KNIGHT LLP, 10 ST. JAMES AVENUE, 11th Floor, BOSTON, MA, 02116-3889, US

(21) Appl. No.: 12/101,461

(22) Filed: Apr. 11, 2008

(30) Foreign Application Priority Data
Apr. 11, 2007 (TW) 096112769

(51) Int. Cl. B60C 23/00; B60Q 1/00

(52) U.S. Cl. 340/438; 340/447

(57) ABSTRACT

A tire identification system for use in a vehicle, a tire pressure monitoring system using the same and a method for tire identification are disclosed. The vehicle comprises a plurality of tires and a receiver. Each of the tires comprises a tire identification code. The receiver is used to receive signals. The tire identification system comprises a plurality of memory cards and a remote control device, wherein each of the memory cards comprises a memory card identification code that corresponds to each tire identification code, respectively. Moreover, each of the memory cards can be detachably connected to the remote control device in response to each of the tires. The remote control device comprises a signal transmitter to send a signal with each of the memory card identification codes to the vehicle.

### CROSS-REFERENCE TO RELATED APPLICATION

This application claims the benefit of priority based on Taiwan Patent Application No. 096112769 filed on Apr. 11, 2007, the disclosure of which is incorporated herein by reference in its entirety.

### BACKGROUND OF THE INVENTION

1. Field of the Invention

The subject invention relates to a monitoring device and a monitoring method for a manufacturing process. The invention especially relates to a monitoring system and method for detecting a plasma reaction.

2. Descriptions of the Related Art

Traffic safety is always important when vehicles are used. Accordingly, vehicle safety guards have gradually developed and changed in response to the safety concerns. For example, previous passive safety approaches, such as seat belts, air bags, etc., have been developed for a long time. In addition, recently, some active safety approaches, such as ABSs (Antilock Brake System), AFSs (Adaptive Front Lighting System), etc., have been develop quickly as well.

Generally, it is difficult to prevent traffic accidents resulting from faulty tire when vehicles are moving at high speeds. Based on the statistics, 70% of traffic accidents are caused by tire bursts. Therefore, it is important to develop an active safety approach to monitoring tires and preventing them from bursting.

In response to the safety concern, a tire pressure monitoring system (TPMS) for monitoring the tires of a moving vehicle has gradually developed. The TPMS automatically monitors the tire pressure of a moving vehicle while simultaneously delivering an alert to the driver in cases of certain critical situations, such as gas leakage and insufficient pressure.

Presently, two common TPMSs are popular, indirect and direct. The former uses a tire sensor in the ABS system to obtain rotation speed differences among the tires to monitor tire pressure. However, this system does not apply when more than two tires have faults or the speed is over one hundred kilometers per hour. On the other hand, the direct TPMS mainly includes a sensor 10 for pressure, temperature or acceleration, a transmitting module 20 and a receiving module 30, as shown in FIG. 1. Briefly, this direct system uses the pressure sensor 10 configured in each tire to measure tire pressure directly, and then, transmits the data signals via the transmitting module 20 in radio frequency to the receiving module 30. The receiving module 30 is configured in the control desk of the vehicle and displays those data to the driver.

Moreover, those data shown to the driver comprises monitoring parameters, such as tire pressure, temperature. Drivers are notified of the pressure condition of each tire via those parameters. In certain critical conditions, such as when the tire is under or over pressure, the tire is leaking gases, or the temperature is getting higher, the system will automatically deliver alerts to the driver so that the driver can take action in response to the alerts. In view of the developing trend, the direct TPMS is superior to the indirect TPMS.

It is noted that the direct TPMS must individually monitor each tire on the vehicle so that each tire thereof must be effectively identified. The system developed thus far uses a technique with a micro-electro-mechanical system (MEMS) to configure the data processing unit with an identification (ID) code into the pressure/temperature sensors. The system also uses another technique with radio frequency identification (RFID) so that the monitoring parameters for each tire received by the control desk include each tire's ID code to differentiate each tire. More specifically, the RFID uses radio frequency for data transmission in the form of radio communication and uses the ID of an RFID tag to differentiate each of the tires.

The tire pressure monitoring system not only has to reset each tire's ID code when a new vehicle has tires assembled, but also when a new tire replaces a worn one. A common method for a driver to reset each tire's ID code for the monitoring system is to hold a portable receiver while walking around the vehicle to receive each ID code that is transmitted by each tire in the different positions of the vehicle.

As expected, the aforementioned method is time-consuming. Particularly, when the weather condition is worse, it is inconvenient for the driver to walk around the vehicle to reset each tire's ID code. Moreover, when the vehicle assembles a plurality of tires, such as, six or eight tires, the neighboring tires are too close for the monitoring system to differentiate between each of them. Furthermore, ID codes need to be reset when different vehicles are attached to existing vehicles. For example, in a truck with a tractor and a detachable trailer, the tractor has to reset each tire's ID code when different trailers are selected for attachment. Thus, the procedure is complicated and time-consuming.

Another method for differentiating each tire is by leaking and filling air into each tire. However, this method is complicated and consumes time as well.

Therefore, it is important to improve the current direct TPMS to provide vehicle users with a simple, convenient and reliable tire identification method so that TPMS can be a more popular method for traffic safety.

### SUMMARY OF THE INVENTION

One objective of the subject invention is to provide a tire identification system for use in a vehicle. The vehicle has a plurality of tires equipped on the wheels and a receiver. Each of the tires has a corresponding tire identification code. The tire identification system comprises a plurality of memory cards and a remote control device. Each of the memory cards has a memory card identification code, corresponding to one tire identification code respectively. Moreover, each of the memory cards corresponds to one of the tires and can be detachably connected to the remote control device. The remote control device comprises a signal transmitter that sends a signal with each of the memory card identification codes.

Another objective of the subject invention is to provide a tire pressure monitoring system for use in a vehicle. The vehicle has a plurality of tires equipped on the wheels. The tire pressure monitoring system comprises a plurality of tire pressure detecting modules, a plurality of memory cards, a remote control device, and a receiver. The pressure detecting modules is used to detect each of the tires' internal pressure, wherein each of the tire pressure detecting modules has a tire identification code that corresponds to one tire, respectively. Likewise, each of the memory cards has a memory card identification code that corresponds to one of the tire identification codes respectively. Again, each of the memory cards corresponds to one of the tires and can be detachably connected to the remote control device. The remote control device comprises a signal transmitter that sends a signal with each of the memory card identification codes to the receiver.

Yet another objective of the subject invention is to provide a tire identification method for use in a vehicle. The vehicle has a plurality of tires equipped on the wheels. Each of the tires has a corresponding tire identification code. The tire identification method comprises the following steps: (a) providing a plurality of memory cards, wherein each of the memory cards has a memory card identification code that corresponds to one of the tire identification codes respectively; (b) providing a remote control device; (c) plugging each of the memory cards into the remote control device, wherein each of the memory cards corresponds to one of the tires; and (d) sending a signal with each of the memory card identification cods to the vehicle.

The detailed technology and preferred embodiments implemented for the subject invention are described in the following paragraphs accompanying the appended figures for people skilled in this field to well appreciate the features of the claimed invention.

### BRIEF DESCRIPTION OF THE DRAWINGS

FIG. 1 depicts an exemplary embodiment of a direct TPMS of the prior art;

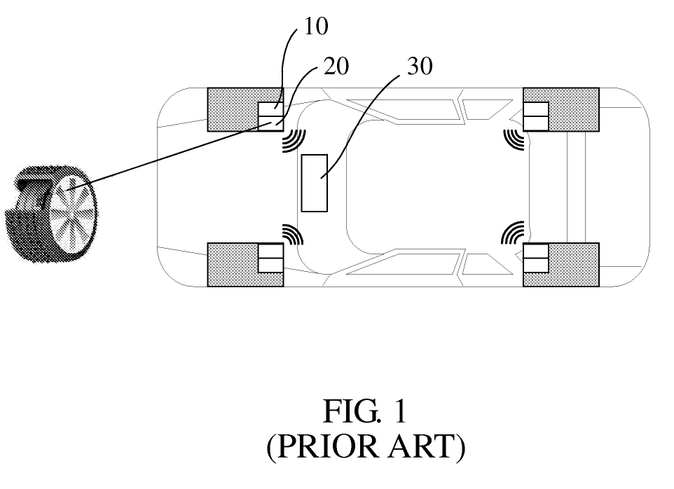

FIG. 2 depicts an exemplary embodiment of a tire identification system and a tire pressure monitoring system of the present invention;

FIG. 3 depicts an exemplary embodiment of applying the present invention to a vehicle with four wheels;

FIG. 4 depicts an exemplary embodiment of applying the present invention to a truck; and

FIG. 5 depicts an exemplary embodiment of applying the present invention to a truck with a tractor and a detachable trailer.

### DESCRIPTION OF THE PREFERRED EMBODIMENT

It is noted that the term “vehicle” is used in the present invention to refer to any automatic vehicle with a plurality of tires that are equipped on the wheels, such as motorcycles, cars, buses, trucks, and motor-trolleys equipped with tires. The vehicle types illustrated in the following embodiments are only for explanation and are not limitations of the invention.

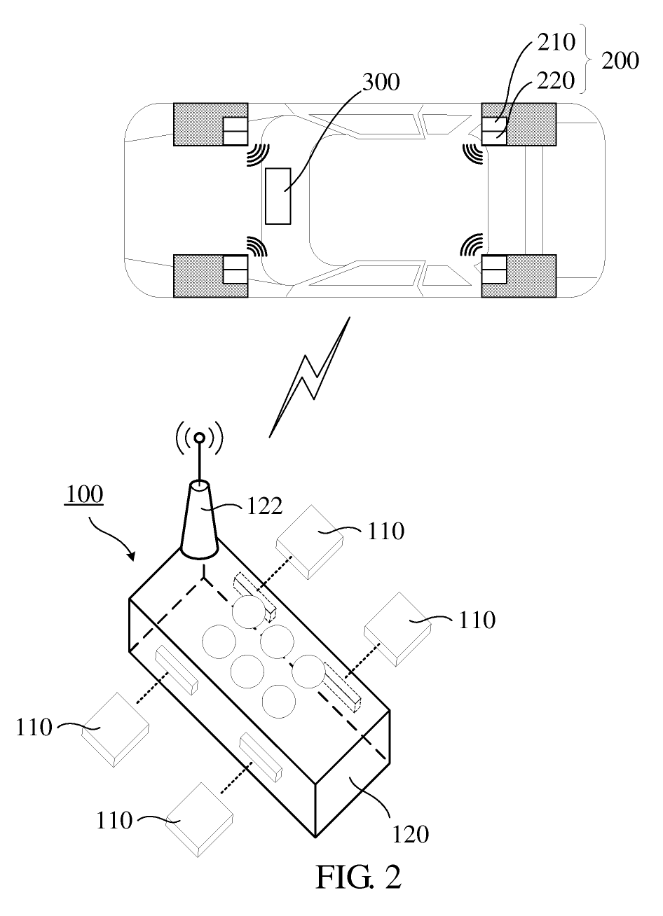

FIG. 2 illustrates a tire identification system for use in a vehicle and a tire pressure monitoring system with the tire identification system. As illustrated above, the different numbers of the tires are equipped on the automatic vehicle according to the vehicle type it belongs to. The tire pressure monitoring system comprises a tire identification system 100, a plurality of tire pressure detecting modules 200 with numbers that corresponds to the number of tires on the vehicle and a receiver 300.

The tire pressure detecting module 200 comprises a pressure detecting device 210 and a second signal transmitter. The pressure detecting device 210 is used to detect each of the tiress' internal pressure. The second signal transmitter 220 uses radio waves to send a tire pressure signal, detected by the pressure detecting device 210, to the receiver 300. Moreover, the present invention sets a tire identification (ID) code with proper bits, 32 bits for example, to each tire pressure detecting module 200 to ensure that the pressure monitoring system of the present invention can provide sufficient ID codes for global use. It is noted that the tire ID codes can be integrated into tire pressure signals so that the monitoring system can differentiate between each of them easily.

More specifically, after configuring each tire pressure detecting module 200 to the inner sidewall or valve nozzle of each tire, or fixing it to each wheel, each tire comprises its corresponding tire ID code. Compared with the prior art, one of the features of the invention is that the tire pressure monitoring system uses the tire identification system 100 for effectively and simply setting tire ID codes for each tire. The tire identification system 100 comprises a plurality of memory cards 110 and a remote control device 120. Each of the memory cards 110 has a memory card ID code which corresponds to one of the tire identification codes respectively. That is, because each memory ID code has a specific tire ID code, each memory card 110 is specific to only one tire. Moreover, each of the memory cards 110 can be detachably connected to the remote control device 120. The remote control device 120 comprises a first signal transmitter 122, configured therein, that uses radio waves to send the signal with each memory card ID code to the receiver 300.

As mentioned above, any coding method can be used to create the corresponding relationship between the memory card ID code and the tire ID code by those skilled in the art, as long as the coding method results in a one-on-one corresponding relationship. In the preferred embodiment, the memory card ID code is the same as the tire ID code. That is, in the embodiment of the 32-bit tire ID code, each memory card 110 corresponding to each tire has a 32-bit memory card ID code which is the same as the corresponding tire ID code. This is the simplest one-on-one corresponding relationship for tire identification.

In another preferred embodiment, a certification code with proper bits, such as 16 bits, can be added into the memory card ID code and the tire ID code to confirm the accuracy received by the receiver. The relationship among the certification code, the memory card ID code and the tire ID code can be, for example but not limited to, a logical calculation so that the decimal number of the certification code is the sum of the decimal numbers representing the memory card ID code or the tire ID code to ensure the accuracy of the memory card ID codes and the tire ID codes received by the receiver 300. If the certification code has an error, the monitoring system can request the tire pressure detecting module 200 to re-transmit the tire pressure signal again and re-certify the code again.

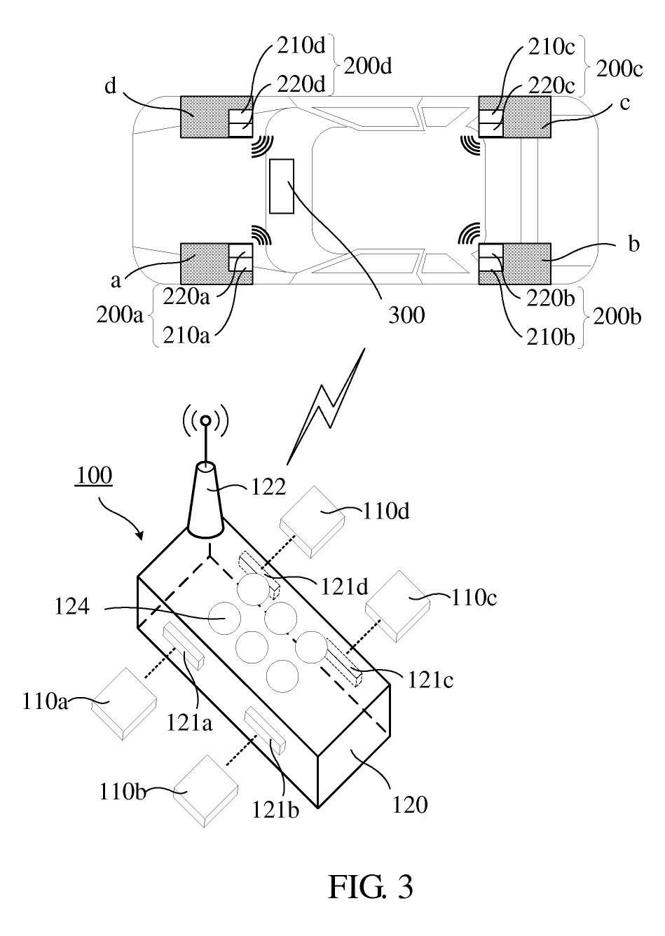

The present invention can dispose a plurality of memory card connectors corresponding to the different tire configuration of each vehicle so that each memory card 110 can detachably plug into the remote control device 120. For example, FIG. 3 illustrates a car with four tires, i.e. tire a, tire b, tire c, and tire d. Accordingly, the remote control device 120 disposes four slots for containing the four memory card connectors 121a, 121b, 121c, and 121d therein, which correspond to the tires a, b, c, and d, respectively. Therefore, the memory cards 110a, 110b, 110c and 110d corresponding to tires a, b, c, and d must be plugged into the memory card connectors 121a, 121b, 121c, and 121d respectively.

More specifically, when the four tire pressure detecting modules 200a, 200b, 200c, and 200d, each having different tire ID codes, are equipped in tires a, b, c, and d, the four memory cards 110a, 110b, 110c and 110d are plugged into the memory card connectors 121a, 121b, 121c, and 121d respectively. The first signal transmitter 122 of the remote control device 120 can send signals, containing each memory card ID code, to the receiver 300 so that the tire pressure monitor system can set tire ID codes for tires a, b, c, and d according to the memory card ID codes of the memory cards 110a, 110b, 110c and 110d respectively. After the tire pressure detecting modules 200a, 200b, 200c, and 200d detect each tire pressure of tires a, b, c, and d, the second signal transmitters 220a, 220b, 220c, and 220d of the modules can transmit the tire pressure signals of each tire in combination with each corresponding tire ID code to the receiver 300 to provider instant information to the driver about each tire's condition.

In the preferred embodiment, the remote control device 120 of the present invention should be portable to facilitate the user's operation. However, if there are many vehicles nearby, the remote control devices of the different vehicles in a small area (such as within a radius of 20 meters) will easily interfere with each other. To prevent interference, the remote control device 120 of the present invention further comprises a dip switch, used to set the remote control device ID code (for example, 8 to 16 bits) which can be sent to the receiver 300 via the first signal transmitter 122 so that the vehicle is able to identify its corresponding remote control device.

Moreover, according to the application and type of sensors, the remote control device 120 of the present invention can dispose at least one setting module 124 which can be used to set the safety range for each of the tires' monitoring parameters. For example, the setting module can set several monitoring parameters for the tire pressure, temperature, acceleration, etc, so that the safety ranges of those parameters can be dynamically adjusted to provide effective and instant information to the driver.

In addition, the receiver 300 of the tire pressure monitoring system can be integrated into the control desk's display of the vehicle. The driver can then obtain the updated information, including each tire's pressure, of the vehicle at any time via the display on the control desk. Thus, traffic safety is effectively increased.

The tire identification system and the tire pressure monitoring system with the tire identification system of the present invention have several advantages, that is, it is easier to set, saves time and results in clear differentiation of the tires. Furthermore, because there is a corresponding one-on-one relationship among the memory cards, the remote control device and the tires, a specific memory card can be plugged into the corresponding memory card connectors of the remote control device to transmit the new memory card ID codes to the receiver. That is, when there is a need for re-identifying tires, such as assembling new tires, replacing worn tires or switching tires to different positions, the memory cards can be replaced to re-identify those tires. Therefore, the present invention can easily identify the neighboring tires without any difficulty.

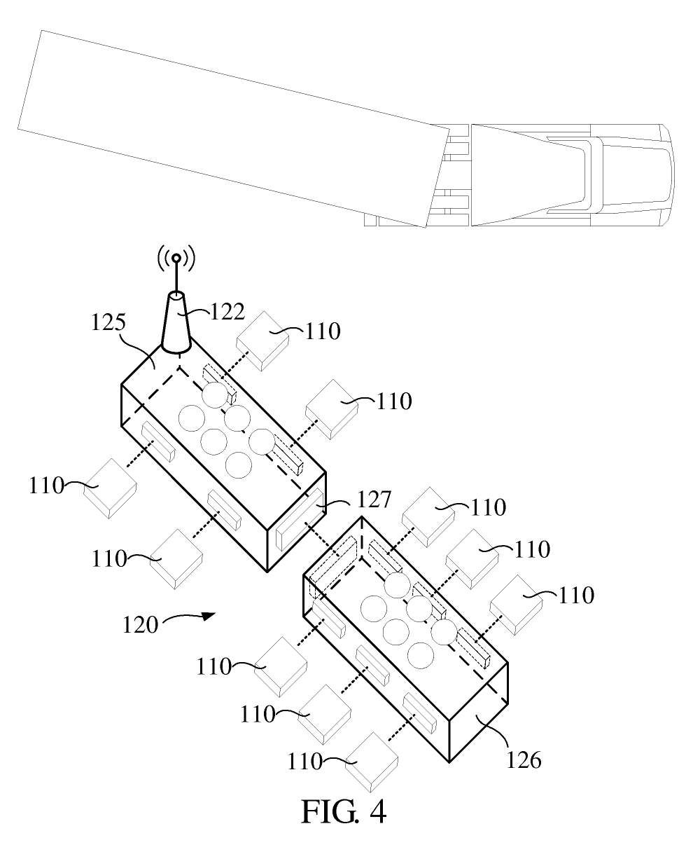

In the aforementioned case of the tractor and detachable trailer, the present invention can effectively speed up the identification process. In FIG. 4, the remote control 120 comprises two modules, a tractor remote control module 125, a trailer remote control module 126 and a connector 127, used to detachably connect the tractor remote control module 125 and the trailer remote control module 126. As mentioned above, the tire pressure detecting modules, with the same number of the tires configured in the tractor and trailer, are equipped on the corresponding tires. The memory cards, with the same number of the tires, are disposed respectively in the tractor remote control module 125 and the trailer remote control module 126. The first signal transmitter of the system can be disposed in either the tractor remote control module 125 or the trailer remote control module 126.

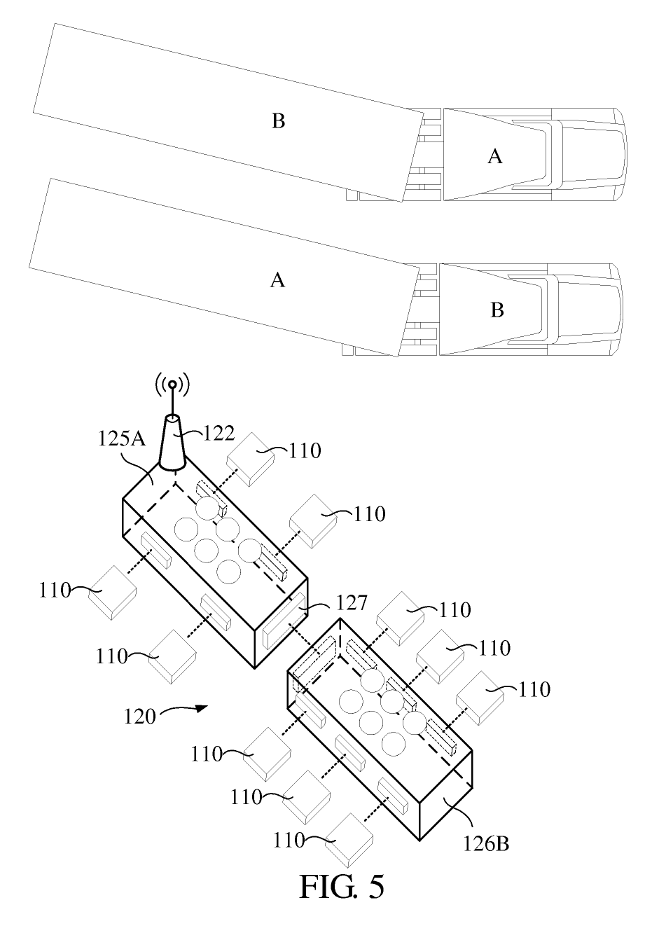

When there are two detachable remote control modules, the complicated procedures of resetting the tire ID codes can be simplified. For example, in FIG. 5, when trailer A, originally grouped with tractor A, is replaced by trailer B, the only thing the user needs to do is to connect the tractor remote control module 125A, corresponding to tractor A, with the trailer remote control module 126B, corresponding to trailer B, via the connector 127. Therefore, as compared to the prior art, the tire pressure monitoring system disclosed by the invention can provide a simple and quick tire identification system and method for the matching of different tractors and trailers.

Applying the aforementioned tire identification system, the present invention further provides a tire identification method for use in a vehicle. The vehicle has a plurality of tires equipped on the wheels. Each of the tires has a corresponding tire identification code. The tire identification method comprises the following steps:

(a) providing a plurality of memory cards, wherein each of the memory cards has a memory card identification code, corresponding to one tire identification codes respectively;

(b) providing a remote control device;

(c) plugging each of the memory cards into the remote control device, wherein each of the memory cards corresponds to one tire; and

(d) sending a signal with each memory card identification code to the vehicle

The above examples are only intended to illustrate the principle and efficacy of the subject invention, and not to limit the subject invention. Any people skilled in this field may proceed with modifications and changes to the above examples without departing from the technical principle and spirit of the subject invention. Therefore, the scope of protection of the subject invention is covered in the following claims as appended.

What is claimed is:

1. A tire identification system for use in a vehicle, the vehicle having a plurality of tires and a receiver, each of the tires having a tire identification code, the tire identification system comprising:
a plurality of memory cards, wherein each of the memory cards has a memory card identification code, corresponding to one of the tire identification codes respectively; and
a remote control device, wherein each of the memory cards corresponds to one of the tires and can be detachably connected to the remote control device, and the remote control device comprises a signal transmitter to send a signal with each of the memory card identification codes.

2. The tire identification system of claim 1, wherein each of the memory card identification codes and the corresponding tire identification code have the same identification code.

3. The tire identification system of claim 1, wherein each of the tire identification codes and each of the memory card identification codes have 32 bits.

4. The tire identification system of claim 1, wherein the remote control device further comprises a dip switch, used to set a remote control device identification code, sent to the receiver by the signal transmitter for the vehicle to identify the remote control device.

5. The tire identification system of claim 1, wherein the remote control device further comprises a plurality of memory card connectors, used to detachably connect each of the memory cards to the remote control device, for obtaining each of the memory card identification codes.

6. The tire identification system of claim 1, wherein the signal transmitter sends the signal to the receiver by radio waves.

7. The tire identification system of claim 1, wherein when the vehicle is a truck having a tractor and a trailer, the remote control device further comprises:
a tractor remote control module;
a trailer remote control module; and
a connector,
wherein each of the memory cards respectively corresponds to one of the tractor's tires and the trailer's tires and can be connected to the tractor remote control module and the trailer remote control module, and the tractor remote control module can use the connector to be detachably connected to the trailer remote control module.

8. The tire identification system of claim 7, wherein the signal transmitter can be equipped in either of the tractor remote control module or the trailer remote control module.

9. The tire identification system of claim 1, wherein the remote control device further comprises a setting module, used to set a safety range for each of the tires' monitoring parameters.

10. A tire pressure monitoring system for use in a vehicle, the vehicle having a plurality of tires, the tire pressure monitoring system comprising:
a plurality of tire pressure detecting modules, used to detect each of the tires' pressure, wherein each of the tire pressure detecting modules has a tire identification code, corresponding to one of the tires respectively;
a plurality of memory cards, wherein each of the memory cards has a memory card identification code, corresponding to one of the tire identification codes respectively;
a remote control device, wherein each of the memory cards corresponds to one of the tires and can be detachably connected to the remote control device, and the remote control device comprises a signal transmitter to send a signal with each of the memory card identification codes; and
a receiver, used to receive the signal.

11. The tire pressure monitoring system of claim 10, wherein each of the memory card identification codes and the corresponding tire identification code have the same identification code.

12. The tire pressure monitoring system of claim 10, wherein each of the tire identification codes and each of the memory card identification codes have 32 bits.

13. The tire pressure monitoring system of claim 10, wherein the remote control device further comprises a dip switch, used to set a remote control device identification code, sent to the receiver by the signal transmitter for the vehicle to identify the remote control device.

14. The tire pressure monitoring system of claim 10, wherein the remote control device further comprises a plurality of memory card connectors, used to detachably connect each of the memory cards to the remote control device, for obtaining each of the memory card identification codes.

15. The tire pressure monitoring system of claim 10, wherein the signal transmitter sends the signal to the receiver by radio waves.

16. The tire pressure monitoring system of claim 10, wherein each of the tire pressure detecting modules further comprises:
a pressure detecting device, used to detect each of the tires' pressure; and
a second signal transmitter, used to send a tire pressure signal detected by the pressure detecting device to the receiver, wherein the tire pressure signal comprises each of the tire identification codes.

17. The tire pressure monitoring system of claim 10, wherein when the vehicle is a truck having a tractor and a trailer, the remote control device further comprises:
a tractor remote control module;
a trailer remote control module; and
a connector,
wherein each of the memory cards respectively corresponds to one of the tractor's tires and the trailer's tires and can be connected to the tractor remote control module and the trailer remote control module, and the tractor remote control module can use the connector to be detachably connected to the trailer remote control module.

18. The tire pressure monitoring system of claim 17, wherein the signal transmitter can be equipped in either of the tractor remote control module or the trailer remote control module.

19. The tire pressure monitoring system of claim 10, wherein the remote control device further comprises a setting module, used to set a safety range for each of the tires' monitoring parameters.

20. A tire identification method for use in a vehicle, the vehicle having a plurality of tires, each of the tires having a tire identification code, the tire identification method comprising:
providing a plurality of memory cards, wherein each of the memory cards has a memory card identification code, corresponding to one of the tire identification codes respectively;
providing a remote control device;
plugging each of the memory cards into the remote control device, wherein each of the memory cards corresponds to one of the tires; and
sending a signal to the vehicle, wherein the signal having each of the memory card identification codes.
